(19) United States
(12) Patent Application Publication
(10) Pub. No.: US 2007/0288968 A1
(43) Pub. Date: Dec. 13, 2007

(54) Video and data home networking architectures

(76) Inventor: John L. Norin, Redondo Beach, CA (US)

Correspondence Address: THE DIRECTV GROUP, INC.;PATENT DOCKET ADMINISTRATION, CA / LA1 / A109, P O BOX 956, EL SEGUNDO, CA, 90245-0956, US

(21) Appl. No.: 11/810,797

(22) Filed: Jun. 7, 2007

Related U.S. Application Data
(60) Provisional application No. 60/812,197, filed on Jun. 9, 2006.
(60) Provisional application No. 60/812,165, filed on Jun. 9, 2006.

(51) Int. Cl. H04N 7/20

(52) U.S. Cl. 725/63; 725/68; 725/67

(57) ABSTRACT

Architectures and systems for delivering satellite signals to a receiver are disclosed. A system in accordance with the present invention comprises a gateway, comprising a tuner, a processor, coupled to the tuner, a converter, coupled to the processor, wherein the tuner tunes to a selected satellite signal and forwards information contained in the satellite signal to the CPU, which processes the information and forwards it to the converter; and an output from the converter for delivering the converted processed information, and a client, coupled to the gateway, wherein the client receives the converted processed information.

### CROSS REFERENCE TO RELATED APPLICATIONS

This application claims the benefit under 35 U.S.C. §119(e) to U.S. Provisional Patent Application Ser. No. 60/812,197, filed on Jun. 9, 2006, by John L. Norin, entitled “VIDEO AND DATA HOME NETWORKING ARCHITECTURES,” which application is incorporated by reference herein.

### BACKGROUND OF THE INVENTION

1. Field of the Invention.

The present invention relates generally to a satellite receiver system, and in particular, to an antenna assembly for such a satellite receiver system.

2. Description of the Related Art.

Satellite broadcasting of communications signals has become commonplace. Satellite distribution of commercial signals for use in television programming currently utilizes multiple feedhorns on a single Outdoor Unit (ODU) which supply signals to up to eight IRDs on separate cables from a multiswitch.

FIG. 1 illustrates a typical satellite television installation of the related art.

System 100 uses signals sent from Satellite A (SatA) 102, Satellite B (SatB) 104, and Satellite C (SatC) 106 (with transponders 28, 30, and 32 converted to transponders 8, 10, and 12, respectively), that are directly broadcast to an Outdoor Unit (ODU) 108 that is typically attached to the outside of a house 110. ODU 108 receives these signals and sends the received signals to IRD 112, which decodes the signals and separates the signals into viewer channels, which are then passed to television 114 for viewing by a user. There can be more than one satellite transmitting from each orbital location.

Satellite uplink signals 116 are transmitted by one or more uplink facilities 118 to the satellites 102-106 that are typically in geosynchronous orbit. Satellites 102-106 amplify and rebroadcast the uplink signals 116, through transponders located on the satellite, as downlink signals 120. Depending on the satellite 102-106 antenna pattern, the downlink signals 120 are directed towards geographic areas for reception by the ODU 108.

Each satellite 102-106 broadcasts downlink signals 120 in typically thirty-two (32) different sets of frequencies, often referred to as transponders, which are licensed to various users for broadcasting of programming, which can be audio, video, or data signals, or any combination. These signals have typically been located in the Ku-band Fixed Satellite Service (FSS) and Broadcast Satellite Service (BSS) bands of frequencies in the 10-13 GHz range. Future satellites will likely also broadcast in a portion of the Ka-band with frequencies of 18-21 GHz

FIG. 2 illustrates a typical ODU of the related art.

ODU 108 typically uses reflector dish 122 and feedhorn assembly 124 to receive and direct downlink signals 120 onto feedhorn assembly 124. Reflector dish 122 and feedhorn assembly 124 are typically mounted on bracket 126 and attached to a structure for stable mounting. Feedhorn assembly 124 typically comprises one or more Low Noise Block converters 128, which are connected via wires or coaxial cables to a multiswitch, which can be located within feedhorn assembly 124, elsewhere on the ODU 108, or within house 110. LNBs typically downconvert the FSS and/or BSS-band, Ku-band, and Ka-band downlink signals 120 into frequencies that are easily transmitted by wire or cable, which are typically in the L-band of frequencies, which typically ranges from 950 MHz to 2150 MHz. This downconversion makes it possible to distribute the signals within a home using standard coaxial cables.

The multiswitch enables system 100 to selectively switch the signals from SatA 102, SatB 104, and SatC 106, and deliver these signals via cables 124 to each of the IRDs 112A-D located within house 110. Typically, the multiswitch is a five-input, four-output (5×4) multiswitch, where two inputs to the multiswitch are from SatA 102, one input to the multiswitch is from SatB 104, and one input to the multiswitch is a combined input from SatB 104 and SatC 106. There can be other inputs for other purposes, e.g., off-air or other antenna inputs, without departing from the scope of the present invention. The multiswitch can be other sizes, such as a 6×8 multiswitch, if desired. SatB 104 typically delivers local programming to specified geographic areas, but can also deliver other programming as desired.

To maximize the available bandwidth in the Ku-band of downlink signals 120, each broadcast frequency is further divided into polarizations. Each LNB 128 can receive both orthogonal polarizations at the same time with parallel sets of electronics, so with the use of either an integrated or external multiswitch, downlink signals 120 can be selectively filtered out from travelling through the system 100 to each IRD 112A-D.

IRDs 112A-D currently use a one-way communications system to control the multiswitch. Each IRD 112A-D has a dedicated cable 124 connected directly to the multiswitch, and each IRD independently places a voltage and signal combination on the dedicated cable to program the multiswitch. For example, IRD 112A may wish to view a signal that is provided by SatA 102. To receive that signal, IRD 112A sends a voltage/tone signal on the dedicated cable back to the multiswitch, and the multiswitch delivers the satA 102 signal to IRD 112A on dedicated cable 124. IRD 112B independently controls the output port that IRD 112B is coupled to, and thus may deliver a different voltage/tone signal to the multiswitch. The voltage/tone signal typically comprises a 13 Volts DC (VDC) or 18 VDC signal, with or without a 22 kHz tone superimposed on the DC signal. 13 VDC without the 22 kHz tone would select one port, 13 VDC with the 22 kHz tone would select another port of the multiswitch, etc. There can also be a modulated tone, typically a 22 kHz tone, where the modulation schema can select one of any number of inputs based on the modulation scheme. For simplicity and cost savings, this control system has been used with the constraint of 4 cables coming for a single feedhorn assembly 124, which therefore only requires the 4 possible state combinations of tone/no-tone and hi/low voltage.

To reduce the cost of the ODU 108, outputs of the LNBs 128 present in the ODU 108 can be combined, or “stacked,” depending on the ODU 108 design. The stacking of the LNB 128 outputs occurs after the LNB has received and downconverted the input signal. This allows for multiple polarizations, one from each satellite 102-106, to pass through each LNB 128. So one LNB 128 can, for example, receive the Left Hand Circular Polarization (LHCP) signals from SatC 102 and SatB 104, while another LNB receives the Right Hand Circular Polarization (RHCP) signals from SatB 104, which allows for fewer wires or cables between the feedhorn assembly 124 and the multiswitch.

The Ka-band of downlink signals 120 will be further divided into two bands, an upper band of frequencies called the “A” band and a lower band of frequencies called the “B” band. Once satellites are deployed within system 100 to broadcast these frequencies, the various LNBs 128 in the feedhorn assembly 124 can deliver the signals from the Ku-band, the A band Ka-band, and the B band Ka-band signals for a given polarization to the multiswitch. However, current IRD 112 and system 100 designs cannot tune across this entire resulting frequency band without the use of more than 4 cables, which limits the usefulness of this frequency combining feature.

By stacking the LNB 128 inputs as described above, each LNB 128 typically delivers 48 transponders of information to the multiswitch, but some LNBs 128 can deliver more or less in blocks of various size. The multiswitch allows each output of the multiswitch to receive every LNB 128 signal (which is an input to the multiswitch) without filtering or modifying that information, which allows for each IRD 112 to receive more data. However, as mentioned above, current IRDs 112 cannot use the information in some of the proposed frequencies used for downlink signals 120, thus rendering useless the information transmitted in those downlink signals 120.

It can be seen, then, that there is a need in the art for a satellite broadcast system that can be expanded to include new satellites and new transmission frequencies.

### SUMMARY OF THE INVENTION

To minimize the limitations in the prior art, and to minimize other limitations that will become apparent upon reading and understanding the present specification, the present invention discloses architectures for satellite signal delivery systems.

A system in accordance with the present invention comprises a gateway, comprising a tuner, a processor, coupled to the tuner, a converter, coupled to the processor, wherein the tuner tunes to a selected satellite signal and forwards information contained in the satellite signal to the CPU, which processes the information and forwards it to the converter; and an output from the converter for delivering the converted processed information, and a client, coupled to the gateway, wherein the client receives the converted processed information.

Such a system optionally further comprises the converter being a powerline converter, a wireless converter, or a powerline converter and a wireless converter such that the gateway has an output from the powerline converter and the wireless converter, the client being a client bridge, a remote client, coupled to the client bridge, for receiving the converted processed information via the remote client, where the remote client converts the converted processed information to a format useable by a monitor for display of the information.

Other features and advantages are inherent in the system and method claimed and disclosed or will become apparent to those skilled in the art from the following detailed description and its accompanying drawings.

### BRIEF DESCRIPTION OF THE DRAWINGS

Referring now to the drawings in which like reference numbers represent corresponding parts throughout:

FIG. 1 illustrates a typical satellite television installation of the related art;

FIG. 2 illustrates a typical ODU of the related art;

FIG. 3 illustrates a system diagram of the present invention;

FIG. 4 illustrates an overall system architecture of the present invention;

FIGS. 5 and 6 illustrates typical gateways in accordance with the present invention; and

FIG. 7 illustrates various client boxes envisioned within the scope of the present invention.

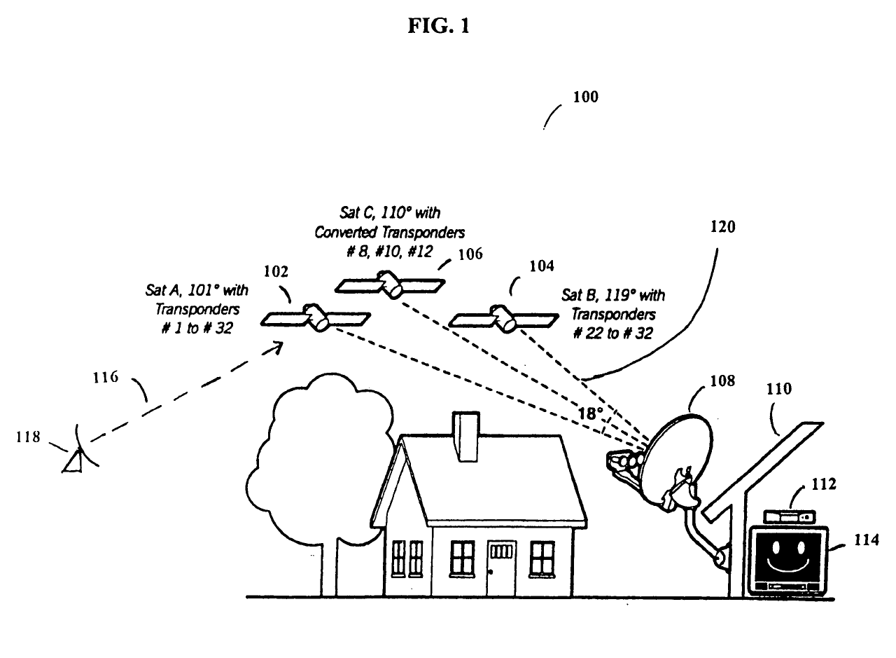

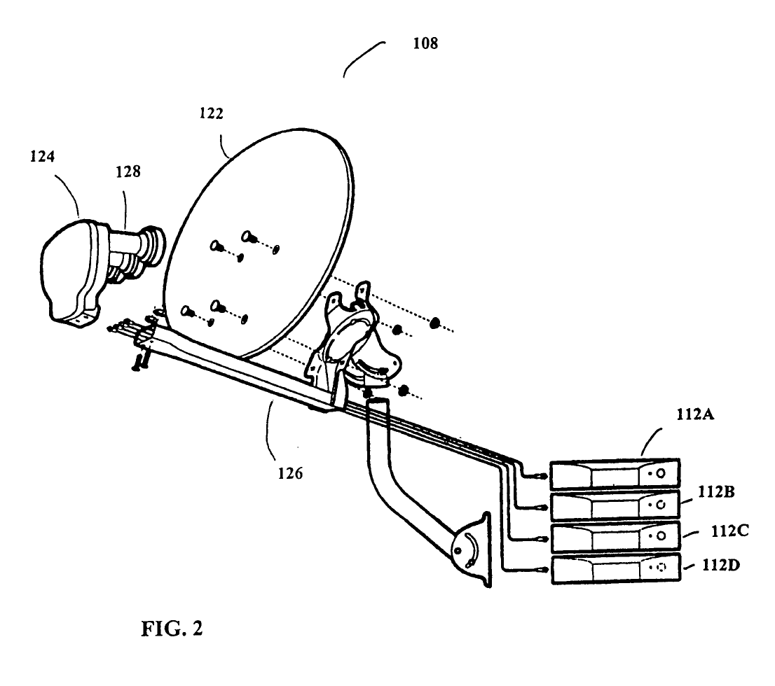

### DETAILED DESCRIPTION OF THE PREFERRED EMBODIMENTS

In the following description, reference is made to the accompanying drawings which form a part hereof, and which show, by way of illustration, several embodiments of the present invention. It is understood that other embodiments may be utilized and structural changes may be made without departing from the scope of the present invention.

Overview

Currently, there are three orbital slots, each comprising one or more satellites, delivering direct-broadcast television programming signals to the various ODUs 108. However, ground systems that currently receive these signals cannot accommodate additional satellite signals without adding more cables, and cannot process the additional signals that will be used to transmit the growing complement of high-definition television (HDTV) signals. The HDTV signals can be broadcast from the existing satellite constellation, or broadcast from the additional satellite(s) that will be placed in geosynchronous orbit. The orbital locations of the Ku-BSS satellites are fixed by regulation as being separated by nine degrees, so, for example, there is a satellite at 101 degrees West Longitude (WL), SatA 102; another satellite at 110 degrees WL, SatC 106; and another satellite at 119 degrees WL, SatB 104. Additional satellites may be at other orbital slots, e.g., 72.5 degrees, 95, degrees, 99 degrees, and 103 degrees, and other orbital slots, without departing from the scope of the present invention. The satellites are typically referred to by their orbital location, e.g., SatA 102, the satellite at 101 WL, is typically referred to as “101.” Additional orbital slots, with one or more satellites per slot, are presently contemplated at 99 and 103 (99.2 degrees West Longitude and 102.8 degrees West Longitude, respectively).

The present invention allows currently installed systems to continue receiving currently broadcast satellite signals, as well as allowing for expansion of additional signal reception and usage.

Multiswitch Port Selection

As described above, typically, the ports of a multiswitch are selected by the IRD 112 sending a DC voltage signal with or without a tone superimposed on the DC voltage signal to select a satellite 102-106. For example, and not by way of limitation, FOX News Channel may be located on transponder 22 from SatB 104. SatB 104 is typically selected by IRD 112 by sending an 18V signal with a 22 kHz tone superimposed on the 18V signal to the multiswitch, which then selects the downlink signal 120 coming from SatB 104. Additional processing is then done on signal 120 within IRD 112 to find the individual channel information associated with FOX News Channel, which is then displayed on monitor 114.

However, when new satellites 102-106 are operational, and additional signals as well as additional frequency bands become available, the currently distributed IRDs 112 must still operate, and new IRDs 112 capable of receiving, demodulating, and forwarding these new downlink signals 120 must also be able to perform these operations on existing and new signals.

The Ka-band of downlink signals 120 is divided into two RF (radio frequency) sub-bands and corresponding Intermediate Frequency (IF) sub-bands, an upper band of frequencies called the “A” band and a lower band of frequencies called the “B” band. Once satellites are deployed within system 100 to broadcast these frequencies, each assembly 124 can deliver the signals from the Ku-band, the A band Ka-band, and the B band Ka-band signals for a given polarization to the integrated or external multiswitch.

By stacking the LNB 128 inputs as described above, each LNB 128 typically delivers 48 transponders of information to the multiswitch, but some LNBs 128 can deliver more or less in blocks of various size. The multiswitch allows each output of the multiswitch to receive every LNB 128 signal (which is an input to the multiswitch) without filtering or modifying that information, which allows for each IRD 112 to receive more data.

New IRDs 112 can use the information in some of the proposed frequencies used for downlink signals 120, and thus the information transmitted in those downlink signals 120 will be available to viewers as separate viewer channels.

Rather than assign new satellite selection codes to the new satellites 102-106, which can be done by using different DC voltages and/or different tones, either alone or in combination, the present invention stacks the signals to allow both legacy (older) IRDs 112 and new IRDs 112 to receive the current downlink signals 120 using the already-known selection criteria (13/18 VDC, with or without 22 kHz tones), and for the new IRDs 112 that can receive and demodulate the new satellite downlink signals 120, those same codes will access the new satellite downlink signals 120, because those signals will be intelligently stacked on top of the current downlink signals 120.

ODU Design and Stacking Plan

In the present invention, the design of the Ka/Ku ODU using the newly-assigned Ka frequency bands (18.3 GHz-18.8 GHz; 19.7 GHz-20.2 GHz), incorporates the current design of millions of Ku (12.2 GHz-12.7 GHz) satellite receivers that are currently distributed to satellite television viewers. The present invention downconverts the Ka-band signals and the Ku-band signals to specific IF signal bands, and selectively combines them to enable the reception of both the Ka and the Ku signals using the traditional satellite selection topology of 13V, 18V, 13V/22 KHz and 18V/22 KHz.

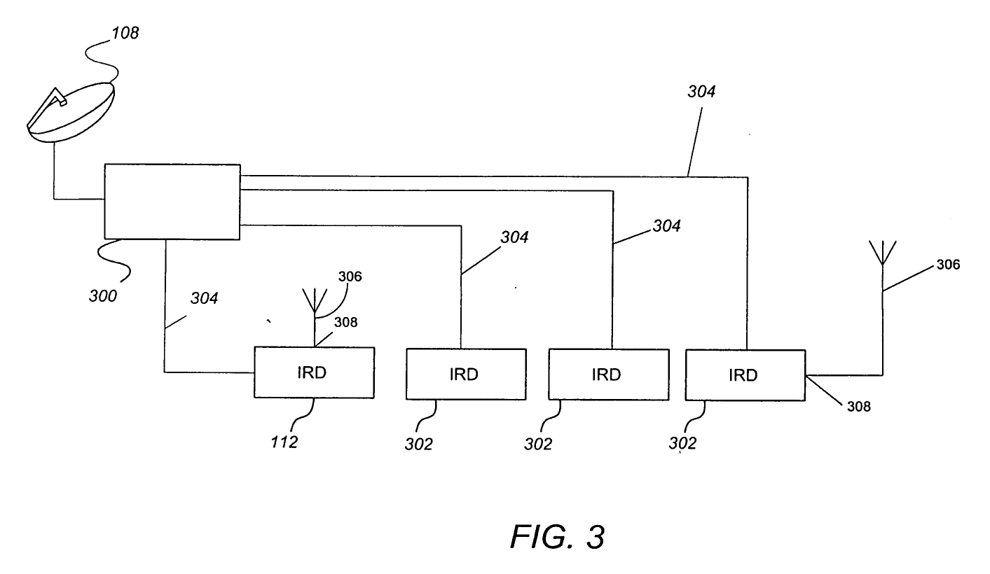

FIG. 3 illustrates a system diagram of the related art.

ODU 108 is coupled to distribution system 300, which is coupled to IRD 112 and new IRDs 302 via cables 304. Each of cables 304 carries commands from IRDs 112 and 302 back to distribution system 300, and also carries signals 120 that are received by ODU 108 and stacked by distribution system 300 in accordance with the present invention.

IRD 112, also referred to as a legacy IRD 112 or a currently deployed IRD 112, is only capable of demodulating signals in the 6b 950-1450 MHz band, because the receiver located in IRD 112 is designed for that frequency band. However, IRD 302 can receive signals over the range of 950-2150 MHz. The 1650-2150 MHz band is usually referred to as the “A-band” or “Ka-high band” IF, while the 250-750 MHz band is referred to as the “B-band” or “Ka-low band” IF, as these bands are populated with downlink signals 120 that have been downconverted from the Ka-band. The 950-1450 MHz band is downconverted from the Ku-band of downlink signals 120. Additional functionality in distribution system 300 or in IRD 302 can shift the Ka-low IF to the Ka-high IF as needed by the IRD. Further, IRD 302 may be able to receive Ka-low IF frequencies with additional electronics either between ODU 108, as part of IRD 302, or other methods.

IRDs 112 and 302 also have the ability to connect antenna 306 to port 308, where off-air television signals can be coupled to IRD 112 and/or 302 can be processed by IRDs 112 and 302.

System Diagram

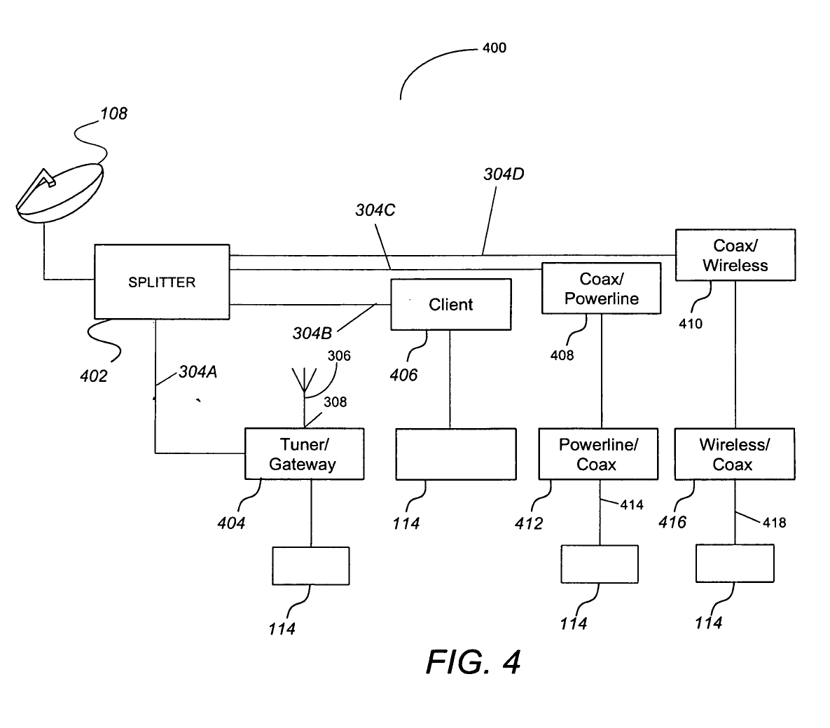

FIG. 4 illustrates an overall system architecture of the present invention.

Rather than connecting ODU 108 directly to each IRD 112/302 directly using cables 304, the present invention envisions an architecture 400 with splitter 402, which allows for all of the satellite downlink signals 120 received by ODU 108 to be sent to individual boxes as before. For example, splitter 402 can send signals on cable 304A to a gateway 404, signals on cable 304B to a client 406, signals on cable 304C to a coax/powerline converter 408, and signals on cable 304D to a coax/wireless converter 410. Gateway 404 is similar to IRD 112 and IRD 302, but will be described further with respect to the present invention. Further, client 406 is also similar to IRD 112 and 302.

Coax/powerline converter 408 is then coupled to powerline/coax converter 412 via the power wires in a house 110, and coax 414 is then coupled to monitor 114. Similarly, coax/wireless converter 410 is coupled via RF transmission to wireless/coax converter 416, which is then connected via coax 418 to monitor 114.

Servers/Gateways

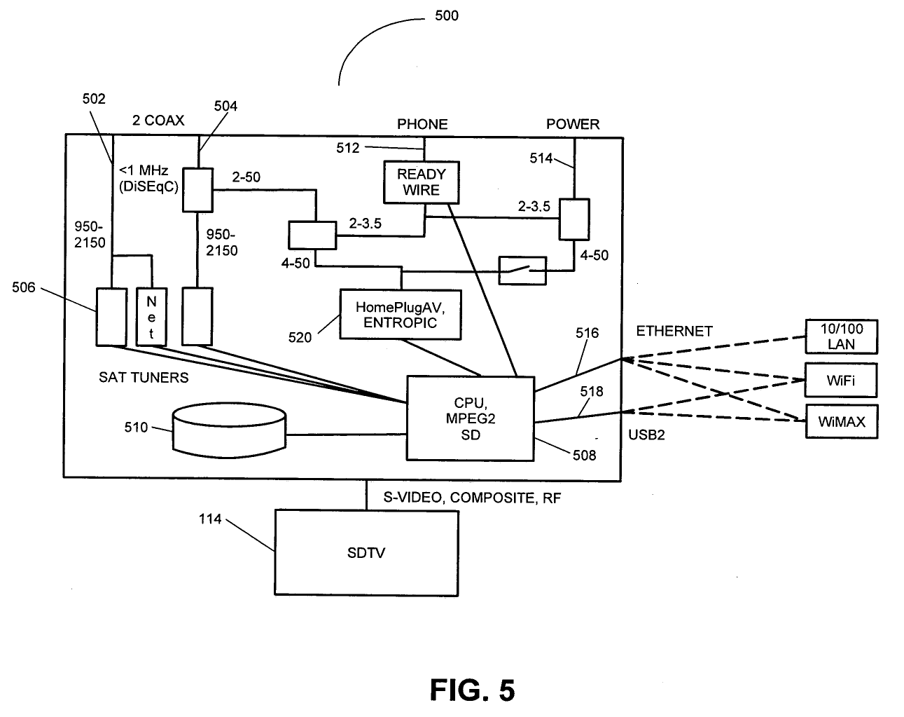

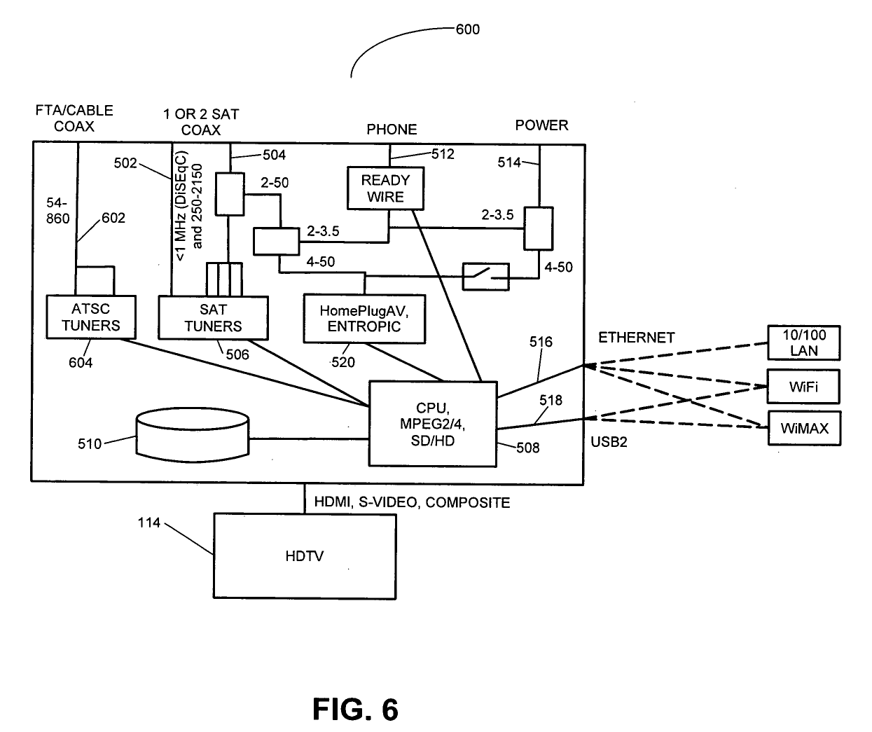

FIGS. 5 and 6 illustrates typical gateways in accordance with the present invention.

FIG. 5 illustrates Standard Definition (SD) gateway 500 which is similar to gateway 404. Connections 502 and 504 are coupled to cable 304, which receive signals from ODU 108. Connection 502 is then coupled to tuners 506, which are coupled to CPU 508. CPU 508 is coupled to disk 510 to control storage of programming on disk 510 when desired by the viewer or the system provider. Phone connection 512 and power connection 514 are also present in gateway 500, along with ethernet connection 516 and USB connection 518. Connection 504 can also be used to couple gateway 500 to other boxes as described hereinbelow.

CPU 508 manages the inputs from connections 502 and 504 to direct the programming present on signals input to connections 502 and 504 to connections 512, 514, 516, and 518, as well as to disk 510 and monitor 114. These signals are SD television signals typically encoded in an MPEG-2 format.

FIG. 6 illustrates High Definition (HD) gateway 600 which is similar to gateway 404 and gateway 500. However, HD gateway 600 further includes a separate input 602 with standard ATSC tuners 604, which are also controlled by CPU 508, such that these signals can also be presented on monitor 114.

Module 520 is a version of a coax/powerline converter 408, while connections 516 and 518 provide connections to converters 522 and 524, as well as wired connection 526, which allow the combination of gateway 500 (or gateway 600) and converters 522 or 524 to act as coax/wireless converter 410. As such, gateways 500 and 600 can provide hardwired connections to monitors 114, as well as powerline connections, phone connections, ethernet connections, and wireless connections to other monitors 114 that may be present in house 110.

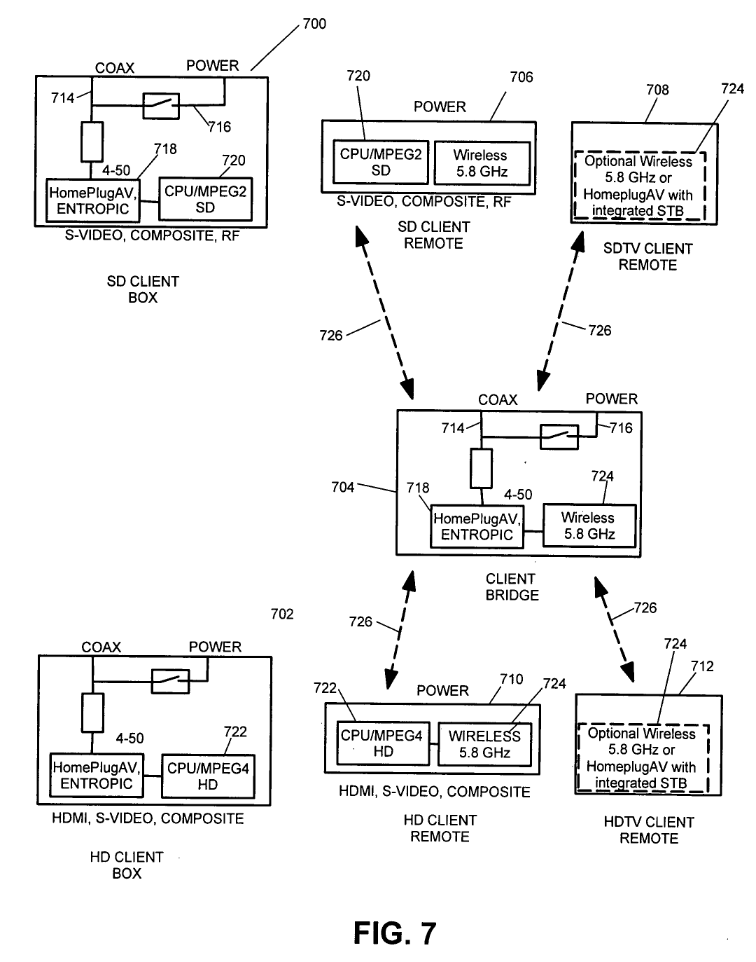

FIG. 7 illustrates various client boxes envisioned within the scope of the present invention.

FIG. 7 illustrates SD client box 700, HD client box 702, and client bridge 704, along with SD client remote 706, integrated SD client remote 708, HD client remote 710 and integrated HD client remote 712.

SD client box 700 comprises a coax input 714 and power input 716, which are connected to converter 718 and CPU 720. When SD client box 700 and SD gateway 500 (or HD gateway 600) are both plugged in to the house 110 power lines, gateway 500 sends programming to SD client box 700 via the power lines through power input 716. Alternatively, or in conjunction, SD client box 700 can receive coaxial inputs through coax input 714, which can be from cable television programming, or from another source if desired, such as gateway 500 or gateway 600.

HD client box 702 is similar to SD client box 700, but HD client box 702 CPU 722 is able to decode MPEG-4 HD television programming, while CPU 720 is typically limited to SD MPEG-2 decoding. Converter 718 is an embodiment of powerline/coax converter 412 shown in FIG. 4

Client bridge 704 again has coax input 714 and power input 716, as well as converter 718. However, client bridge 704 also comprises a wireless transmitter 724, typically transmitting at a 5.8 GHz frequency with transmission power that typically limits the transmissions 726 from client bridge 704 to a short distance, e.g., approximately 30 feet, such that any remote client 706, 708, 710, or 712 that are in transmission 726 range with client bridge 704.

Conclusion

In summary, the present invention comprises architectures and systems for delivering satellite signals to a receiver. A system in accordance with the present invention comprises a gateway, comprising a tuner, a processor, coupled to the tuner, a converter, coupled to the processor, wherein the tuner tunes to a selected satellite signal and forwards information contained in the satellite signal to the CPU, which processes the information and forwards it to the converter; and an output from the converter for delivering the converted processed information, and a client, coupled to the gateway, wherein the client receives the converted processed information.

Such a system optionally further comprises the converter being a powerline converter, a wireless converter, or a powerline converter and a wireless converter such that the gateway has an output from the powerline converter and the wireless converter, the client being a client bridge, a remote client, coupled to the client bridge, for receiving the converted processed information via the remote client, where the remote client converts the converted processed information to a format useable by a monitor for display of the information.

It is intended that the scope of the invention be limited not by this detailed description, but rather by the claims appended hereto and the equivalents thereof. The above specification, examples and data provide a complete description of the manufacture and use of the composition of the invention. Since many embodiments of the invention can be made without departing from the spirit and scope of the invention, the invention resides in the claims hereinafter appended and the equivalents thereof.

What is claimed is:

1 A system for delivering satellite signals to a receiver, comprising:
a gateway, comprising
a tuner,
a processor, coupled to the tuner,
a converter, coupled to the processor, wherein the tuner tunes to a selected satellite signal and forwards information contained in the satellite signal to the processor, which processes the information and forwards it to the converter; and
an output from the converter for delivering the converted processed information; and
a client, coupled to the gateway, wherein the client receives the converted processed information.

2. The system of claim 1, wherein the converter is a powerline converter.

3. The system of claim 1, wherein the converter is a wireless converter.

4. The system of claim 3, wherein the gateway further comprises a powerline converter having an output, such that the gateway has an output from the powerline converter and the wireless converter.

5. The system of claim 3, wherein the client is a client bridge.

6. The system of claim 5, further comprising a remote client, coupled to the client bridge, for receiving the converted processed information via the remote client, the remote client converting the converted processed information to a format useable by a monitor for display of the information.

7. A system for displaying satellite signals, comprising:
an antenna;
a splitter, coupled to the antenna, for splitting the satellite signals into a plurality of split signals, each of the split signals comprising a plurality of video signals;
at least one tuner, coupled to the splitter, for receiving at least one of the split signals;
a processor, coupled to the tuner,
a converter, coupled to the processor, wherein the tuner tunes to a selected video signal in the plurality of video signals and forwards information contained in the selected video signal to the processor, which processes the information and forwards it to the converter;
an output from the converter for delivering the converted processed information; and
a monitor, coupled to the output of the converter, for displaying at least the converted processed information.

8. The system of claim 7, wherein the converter is a powerline converter.

9. The system of claim 7, wherein the converter is a wireless converter.

10. The system of claim 9, further comprising a client, coupled to the tuner, wherein the tuner further comprises a gateway having a powerline converter and a wireless converter.

11. The system of claim 10, wherein the client is a client bridge.

12. The system of claim 11, further comprising a remote client, coupled to the client bridge, for receiving the converted processed information via the remote client, the remote client converting the converted processed information to a format useable by a monitor for display of the information.

14. The system of claim 12, wherein the converted processed information is a standard definition television signal.

15. The system of claim 12, wherein the converted processed information is a high definition television signal.

16. The system of claim 12, wherein the converted processed information comprises a high definition television signal and a standard definition television signal.

17. The system of claim 16, wherein the client bridge delivers the high definition television signal to a high-definition remote client and delivers the standard definition television signal to a standard-definition remote client.

18. The system of claim 17, wherein the high-definition remote client receives the high definition television signal via a radio frequency link.

19. The system of claim 18, wherein the standard-definition remote client receives the standard definition television signal via the radio frequency link.

20. The system of claim 16, wherein the standard-definition remote client receives the standard definition television signal via a power line.
